(19) United States
(12) Patent Application Publication
(10) Pub. No.: US 2009/0113024 A1
(43) Pub. Date: Apr. 30, 2009

(54) Multicase Downloading Using Path Information

(76) Inventors: Snigdha Verma, Somerset, NJ (US); Jun Li, Bridgewater, NJ (US); Junbiao Zhang, Bridgewater, NJ (US)

Correspondence Address: Robert D. Shedd;Thomson Licensing LLC, PO Box 5312, PRINCETON, NJ, 08543-5312, US

(21) Appl. No.: 11/922,762

(22) PCT Filed: Jun. 22, 2005
(86) PCT No.: PCT/US05/22041

§ 371 Date: Dec. 21, 2007

(51) Int. Cl. G06F 15/16; G06F 15/173

(52) U.S. Cl. 709/219; 709/238

(57) ABSTRACT

The downloading of content to a requesting client (A1, A2 and A3) through content distribution network consisting of edge servers occurs upon receiving a content request, a content server responses with a request-routing message that includes source data identifying the content and path data identifying a path through the network to a source of such content. Having the path information in request-routing message enables a requesting client to make the request to a particular edge server, which in turn can register the downloading request and access the content from an appropriate location, thereby obviating the frequent communication between the content server and edge servers on the path.

### TECHNICAL FIELD

This invention relates to methods and systems for delivering content files efficiently.

### BACKGROUND ART

Multimedia digital information files such as those comprising audio, video, movies, and the like, generally have a much greater size compared to most other types of files downloaded via the Internet. Not infrequently, delivery of a requested multimedia file cannot readily occur at the time of the request from a client computer due to network congestion, too much traffic, network priorities, and capacity limitations.

Previous techniques for delivering content have made use of content delivery networks (CDNs), which include-edge servers, located in strategic geographic locations within the network. Content delivery networks can cache content in such edge servers, which derive their name from their geographic locations near the edges of the network. The edge servers provide content to client computers even in cases of network congestion and outage.

The White Paper entitled Internet Bottlenecks: the Case for Edge Delivery Services, published by Akamai Networks and a Network Working Group Internet Draft of Apr. 3, 2003 entitled Known CN Request-Routing Mechanisms, Barbir, et al., describe different techniques for content delivery using edge servers. U.S. Patent Publications 2002016882 of Nov. 7, 2002; 20030065762 of Apr. 3, 2003; 20030002484 of Jan. 2, 2003; and U.S. Pat. No. 6,108,703 to Leighton et al, all incorporated by reference, describe content delivery networks. These documents also describe method of tagging content for delivery from the content delivery network using a migratory and a rewrite tool which rewrites URLs to point to the edge server most likely to host the requested content.

In a downloading service model, for example, a content request by a client does not necessarily reflect an immediate need for the content. Therefore, even if a piece of content is currently not available on an edge server, as long as the content delivery network can deliver the content to the edge server at a future time, the client can have its content request satisfied. The content delivery network satisfies this content request by redirecting the request to an edge server, which will contain the content at the desired time of downloading to the client.

Present day content delivery networks typically operate to deliver content based on network resources and cache capacity. Typically, in response to a content request from a client, the content delivery network will provide the requesting client with a Uniform Resource Locator (URL) that operates as a global address of the requested content. The URL provided to the requesting client typically redirects the client to the closest edge server in the content delivery network that either has the content, or enjoys a link to another upstream edge server linked either directly, or indirectly to a content server. For broadcasting/multicasting content, edge servers can cache a small period of content as the content is streaming. The path by which the edge servers link to a content server generally take the form of a tree-like structure, often referred to as a multicasting tree, in which each edge server appears as a “leaf” linked by a “branch” to a node, either in the form of another edge server, or the content server itself.

Our previous patent application “CACHE SERVER NETWORK AND METHOD OF SCHEDULING THE DISTRIBUTION OF CONTENT FILES WITHIN THE SAME” (PCT US04/07652, filed 12 Mar. 2004) addressed how a multicasting tree can be established for delayed downloading service. Depending on the network configuration, an edge server designated to serve a requesting client because of geographical proximity could lack a direct connection to the content server. As a result, adding a particular edge server to the multicasting tree will require the addition of one or more additional edge servers to provide connectivity for purposes of downloading content. Under such circumstances, each such edge server in the chain would need to communicate with the content server to get information about the edge server immediately upstream. Moreover, a multicasting tree, once created, usually cannot undergo dynamic change to adapt to load balancing. Further, the static nature of the multicasting tree employed by present-day content delivery networks does not permit bypassing of a node, or automatic failure recovery.

Thus, a need exists for a content delivery network that affords greater flexibility and improved performance, while overcoming the aforementioned disadvantages.

### BRIEF SUMMARY OF THE INVENTION

Briefly, in accordance with a preferred embodiment of the present principles, there is provided a method for delivering content to a requesting client. The method commences by returning to content-requesting client content information including source data identifying a source of the piece of content and path data identifying a path to such source. The path data of the client source information received from the requesting client undergoes parsing to identify at least one server via which the requested piece of content will be delivered. Downloading the requested piece of content via the identified server then occurs. Having the path information enables a requesting client to make the request to a particular edge server, which in turn can register the downloading request and access the content from the appropriate upstream location, thereby obviating the need to forward a downloading request directly to an upstream server.

### BRIEF DESCRIPTION OF THE DRAWINGS

FIG. 1 depicts an example of a multicasting tree useful for understanding content delivery in accordance with the prior art.

FIG. 2 depicts an example of a multicasting tree useful for understanding content delivery in accordance with the present principles;

FIG. 3 depicts another example of a multicasting tree useful for understanding content delivery in accordance with the present principles; and

FIG. 4 depicts a modification of the multicasting tree of FIG. 3 showing the addition of a node in response to a request for content from a client.

### DETAILED DESCRIPTION

As described in greater detail hereinafter, the present invention provides a content downloading technique in which the requesting client receives content information, typically in the form of a Uniform Resource Locator (URL) that contains path information descriptive of a path from a server (such as an edge or cache server) serving the client, to the content server containing the content. Such path information affords several advantages, including: (1) the ability to add additional servers (nodes) to the delivery route, hereinafter referred to as a multicasting tree, (2) the ability to readily maintain the multicasting tree should a server become inoperative; and (3) the ability to dynamically update the linkage between servers.

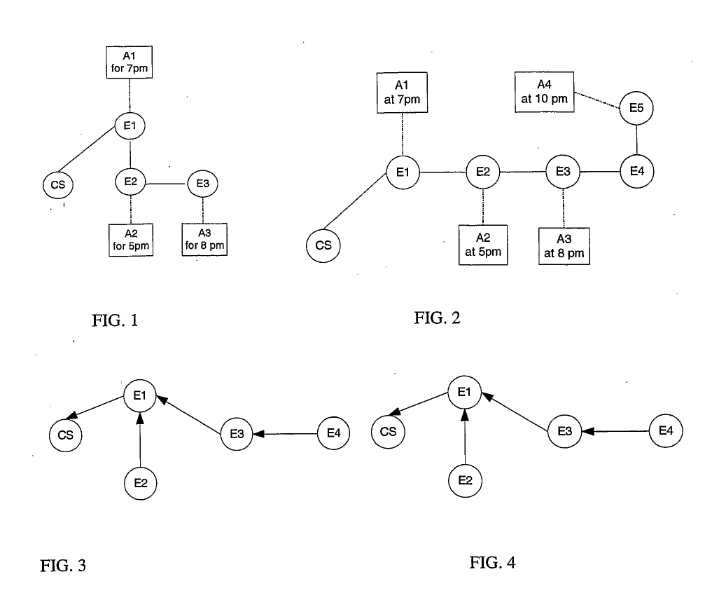

To better understand the content downloading method of the present principles, a description of content downloading in accordance with the prior art will prove helpful. In that regard, refer to FIG. 1, which depicts a multicasting tree constructed associated with content downloading in accordance with the prior art. In the prior art, we assume that the content server receives content requests from clients, and creates multicasting tree for requested content based on content delivery network topology and status. Under this assumption, the content original source, clients' user interface and delayed downloading scheduler all reside on the content server. Although in reality, they can be all different entities, using this assumption for presentation maintains simplicity because the nature of the problem remains unchanged.

For purposes of discussion, assume that no prior content delivery requests exist within a content delivery network, and hence, no multicasting tree exists for the content C1 on a content server CS. Now suppose that clients A1, A3 and A2 make requests for delivery of content C1 at 7 pm, 8 pm, and 5 pm, respectively. For the first request by client A1, the content server establishes a multicasting tree (i.e., a delivery route), which includes a path linking an edge server E1 with the requesting client A1. This path becomes the first branch in the multicasting tree, represented by the relationship:

CS→E1→A1

Upon receiving the redirected request from the content server, the client A 1 will send a request to the edge server E1 who will check its request queue and adds the new request to the queue if the request for the same content C1 does not already exist. When a request for the same content for delivery at 8 pm arrives from client A3, the content server already has created a multicasting tree for the content requested by client A1. To serve the new request from client A3, the content server will add the edge server nearest to client A3, say the edge server E3, as a node to the multicasting tree. Assume for purposes of this discussion that within the structure of the content delivery network, the edge server E3 only possesses a connection to edge server E2. Under such circumstances, the content server will need to add both edge servers E3 and E2 to the multicasting tree. The resultant path associated with the request made by client A3 appears as follows:

CS→E1→E2→E3→A3

A request-routing message is sent back to A3 indicating E3 will serve as the edge server to receive the requested content. Upon receiving the request-routing message, A3 will send a request to E3. E3 checks its request queue and adds the request for content C1 to its request queue. Since E3 doesn't have a previous request for content C1, it needs to forward a request for the content to an upstream server. E3 establishes that its upstream edge server is E2 by either polling or by being pushed from the content server. E2 receives a request from E3 for the content C1. E2 then repeats the same process as E3, so that the request for the content C1 is forwarded to E1. Since E1 already has a request for the content C1, the procedure of adding the new path to the multicasting tree stops for the request generated by A3.

Similarly, when client A2 makes a request for delivery of the content at 5 pm, the content delivery network adds the edge server, say E2, nearest to this requesting client to the multicasting tree. Since edge server E2 already exists within the multicasting tree previously created, the content delivery network does not need to add more nodes to that tree. However, as this content delivery request has a delivery time of 5 pm, earlier than the 8 PM delivery time associated with the content request made by the client A1, E2 needs to send a request with the new delivery time to E1. E1 checks its request queue and add a new request with the earlier delivery time at 5 pm. The path within the multicast tree for the content requested by the client A2 appears as follows:

CS→E1→E2→A2

For a given piece of content, the determination of whether an edge server lies closer to another edge server depends both on the link cost and the caching cost. An optimal multicasting tree minimizes the link cost and caching cost. The link cost depends on the geographic distance between servers. The caching cost depends on the maximum service time difference among all requests for the requested content. In other words, the longer the content is cached at a given server, the greater is the cost of caching such content.

Using this approach, each content request returns one edge server as the redirected local source for content delivery. Although affording simplicity, this approach incurs several disadvantages. As discussed above, the multicasting tree might require the addition of one or more intermediate edge servers to effectively delivery the content to a requesting client. Under such a circumstance, each edge server needs to communicate individually with the content server to get information about its next upstream edge server. Such communications can clog the content delivery network, creating traffic delays.

The above-described prior art approach also incurs the disadvantage that the multicasting tree, once constructed, cannot undergo dynamic changes to adapt to changing pattern of network traffic, and thus cannot effect load balancing. Further, in the event that a failure of a node in the multicasting tree (i.e., the failure of an edge server), most content delivery networks lack the ability to bypass the server or to automatically recover from such an event. Present-day content delivery networks typically require an additional protocol to report or discover a server failure and maintain the multicasting tree intact.

The content delivery technique of the present principles overcomes the aforementioned disadvantages of the prior art by returning to a client, who has made a content request, path information that indicative of the path through the content delivery from the edge server closest to the client to the content server. Thus, when the requesting client gets the path information, that client can make the request to the closest edge server, which in turn parses the path information to identify its upstream server (either an upstream edge server or the content server). Each upstream edge server will parse the request to identify the next upstream server and so on.

To best understand the content delivery technique of the present principles, assume for purposes of discussion that each of the requesting clients has the following distinct paths within the content delivery network:
Requesting client A3 has the following path:

CS→E1→E2→E3→A3

Requesting client A2 has the following path

CS→E1→E2→A2

Requesting client A1 has the following path

CS→E1→A1

To appreciate how returning path information to requesting client enables creation of a multicasting tree, consider the following example, which presupposes that each edge server has a program for scheduled downloading service, hereinafter referred to as SDS. In response to a content request, the content server returns to the requesting client a request-routing message, e.g. a URL, containing content source information. Thus, in this example, the content source information returned to client A1 takes the form of a URL having the following format: http://E1/SDS&path=CS/C1. While using a URL constitutes one technique for providing path information, other mechanisms could exist for embedding path information and for executing scheduled downloading via the edge server.

In response to a content request by client A2, the returned request-routing URL specifying the path will have the following format: http://E2/SDS&path=E1&path=CS/C1. Note that this URL has the added path information specifying the edge server E2. Client A3, upon making a request for the same content, joins the multicasting tree and receives a returned path-containing URL having the following format:

http://E3/SDS&path=E2&path=E1&path=CS/C1.

The advantage afforded in providing full path information becomes most apparent when client A3 gets the redirected path-containing URL

http://E3/SDS&path=E2&path=E1&path=CS/C1. Client A3 uses the path-containing URL to seek the requested content from edge server E3. Upon receipt of the path-containing URL, the edge server E3 uses its scheduled downloading service program (SDS) to first parse the path-containing URL. Thereafter, the edge server E3 registers the request for the content, then queues the request as a downloading request. Finally, the edge server E3 uses the path-containing URL: http://E2/SDS&path=E1&path=CS/C1 to access the upstream edge server E2.

In a similar manner, the SDS program of the edge server E2 will process the request and forward the request to edge server E1, if necessary, until the request reaches the original server or another server that already has the requested content available for delivery at the specified service time. In other words, receiving the path-containing URL from the client at the edge server obviates the need to forward a downloading request to an upstream node.

For each edge server to support downloading in accordance with the present principles the SDS program in the edge server needs to perform: (1) Request parsing to understand the path data in the redirected content information request; (2) Request queuing to register all incoming requests, (3) Request aggregation to queue downloading requests and (4) Request forwarding to send downloading requests to upstream servers.

Providing path information in connection with request routing in accordance with the present principles achieves several advantages. First, providing the path information allows for the addition of multiple servers (nodes) to the multicast tree in one content request. Depending upon the structure of the content delivery network, whether flat or hierarchical, the addition of an edge server to the multicast tree could occur through other servers, which could comprise edge servers or proxy servers. For example, consider the multicasting tree depicted in FIG. 2 in which client A4 makes the request for the same content as clients A1, A2 and A3 and the edge server E5 resides closest to that client. The edge server E5, which serves client A4, has a hierarchical connection to the edge server E4. Under such circumstances, both of the edge servers E4 and E5 become necessary additions to the multicasting tree. Such additions become readily possible because E5 will receive path information about the whole path from the path-containing URL returned by the client A4. On parsing the path-containing URL, the edge server E5 will initiate a connection to the edge server E4 to seek the requested content. In response, the edge server E4 will connect to edge server E3 and so on.

Providing path information in connection with request routing in accordance with the present principles also aids in multicasting tree maintenance. In a typical content delivery network, a possibility exists that any one of the upstream edge servers could lack the ability to service a content request. Upon the failure to receive a response from an upstream edge server, the requesting edge server can bypass that failed node and parse the URL to make a request to a higher upstream edge server. Even if an upstream edge server appears otherwise “healthy,” such a server can lose the content request information due to information inconsistency between that server and the content server. To maintain the information about the multicasting tree for content consistency between edge servers and the content server ordinarily would require the presence of one or additional protocols, which can prove expensive. With the path information in the content information of the request routing, maintenance of the multicasting tree can occur automatically in a distributed way. In particular, bypassing of a failed node or recovery of a failed node can occur without the need to contact the content server.

Further, providing path information in connection with request routing in accordance with the present principles enable dynamic updating. By providing the full path information in the redirected URL for each content request, intermediate edge servers can dynamically update their upstream servers for the content. For example, assume an existing multicast tree that includes the edge servers (nodes) E1, E2 and ES arranged as E3→E2→E1 as shown in FIG. 3. With the illustrated configuration, the edge server E3 has edge server E2 as its upstream edge server for the requested content. For a new request for the same content but with different service time, a new efficient path would exist, as indicated by E4→E3→E1→CS shown in FIG. 4. Based on this new possible path, the edge server E3 dynamically updates its upstream edge server for the content at E1, which would not been possible by without the existence of path information in the returned content information request.

The foregoing describes a technique for delivering content files efficiently by returning a content information request that contains path information descriptive of the path from an edge server serving the client, to the content server.

What is claimed is:

1. A method for delivering content to a requesting client from a content server through a content delivery network containing edge servers, comprising the steps of:
receiving a content request by said content server, from said requesting client;
creating a path of edge servers, by said content server, the path is from said requesting client to a source of the requested content;
returning a request-routing message containing said path, by said content server, to said requesting client to identify at least one edge server via which the client can request the content for delivery.

2. The method according to claim 1 further comprising the steps of
receiving said content delivery request from the client, by an edge server;
parsing the path data within said content request, by said edge server, to identify the at least one server via which the requested piece of content will be delivered; and
forwarding a content request to the identified server by said edge server;
delivering the requested piece of content from the identified server.

3. The method according to claim 1 wherein the step of returning the routing message includes the step of returning a path-containing uniform resource locator (URL).

4. The method according to claim 1 wherein the step of creating a path of edge servers further includes the step of adding the path to a multicasting tree if the path is not a first path for requested content in the content delivery network.

5. The method according to claim 4 further comprising the step of updating the existing multicasting tree to optimize content delivery.

6. The method according to claim 5 further comprising the step of updating the existing multicasting tree dynamically in response to changing conditions.

7. The method according to claim 6 further comprising the step of updating the existing multicasting tree in response to failure of a server within the tree.

8. The method according to claim 6 further comprising the step of updating the existing multicasting tree dynamically in response a change in content availability.

9. The method according to claim 3 wherein the parsing step includes the step of adding at least one server to the multicasting tree in accordance with the path information in the content information.

10. Apparatus for delivering content to a requesting client, comprising:
content server means for (1) receiving a content request from said requesting client, (2) for creating a path of edge servers from said requesting client to a source of the requested content; (3) for returning to a request-routing message containing said path, by said content server, to said requesting client; and (4) for sending a content request, by said requesting client, to at least a first edge server on said path; and wherein
the at least one of the edge server means receiving said content request and parsing the path data within said content request, to identify at least one server via which the requested piece of content will be delivered; and forwarding a content request to the identified server by said edge server; so said identified server can deliver the requested piece of content.

11. The apparatus according to claim 10 wherein the request-routing message comprises a path-containing uniform resource locator.

12. A method for delivering content to a requesting client, comprising the steps of:
responsive to a request from the client for a piece of content, returning to the requesting client content information including source data identifying a source of the content and path data identifying a path to such content source;
receiving from the requesting client the content source information to initiate content delivery;
parsing the path data within the received client source information to identify at least one server via which the requested piece of content will be delivered; and
downloading the requested piece of content via the identified server.
